(19) United States
(12) Patent Application Publication
(10) Pub. No.: US 2025/0166101 A1
(43) Pub. Date: May 22, 2025

(54) SYSTEM AND METHOD FOR MANAGEMENT OF RESOURCES ASSOCIATED WITH AN ENTITY

(71) Applicant: CASALOGY, LLC, Austin, TX (US)

(72) Inventor: Stephen Vigil, Austin, TX (US)

(21) Appl. No.: 19/035,729

(22) Filed: Jan. 23, 2025

Related U.S. Application Data
(63) Continuation-in-part of application No. 17/968,377, filed on Oct. 18, 2022.
(60) Provisional application No. 63/257,380, filed on Oct. 19, 2021.

(51) Int. Cl. G06Q 50/163; G06Q 10/20; G06Q 30/012; G06Q 30/0601

(52) U.S. Cl. CPC G06Q 50/163; G06Q 30/0625; G06Q 30/0631; G06Q 10/20; G06Q 30/012

(57) ABSTRACT

System and method (together termed as mechanism) for management of resources associated with an entity. The mechanism monitors real-time resource status associated with the resources. The mechanism identifies action(s) to be performed on the resource(s). The mechanism generates a context-aware search query related to the action(s). The mechanism executes the context-aware search query to retrieve contents associated with the resource. The mechanism creates a personalized recommendation based on the contents for initiating the action. In an embodiment, the mechanism, through its unified platform, enables different stakeholders to share information and collaborate in order to maintain the resources. The mechanism helps manage the resources, allows users to connect with other entities having similar resources, and allows users to connect with product or service companies or individuals who can help resolve any identified issue. The mechanism enables residents to connect, collaborate, and manage resources efficiently.

### BACKGROUND OF THE INVENTION

The present application is a continuation-in-part of U.S. Non-Provisional application Ser. No. 17/968,377, filed Oct. 18, 2022; which claims the benefit of U.S. Provisional Application No. 63/257,380 filed Oct. 19, 2021; all of which are incorporated herein in their entirety and referenced thereto.

### FIELD OF THE DISCLOSURE

Embodiments of the present invention generally relate to the management of resources. In particular, embodiments of the present invention relate to an interactive system to perform predictive diagnostics and assist in managing or maintaining resources associated with an entity.

### DESCRIPTION OF THE PRIOR ART

An entity, which may be an individual, a house, a commercial establishment, a community, a machine, or the likes, may have several resources that need regular service or maintenance. For example, a home may have several resources, such as electrical appliances, mechanical components, HVAC systems, etc., that need to be maintained regularly. Similarly, a community may have several resources, such as a central electrical supply, water supply system, drainage system, central HVAC system, etc., that need to be maintained regularly. A typical consumer's home contains or is made up of various structural elements, appliances, equipment, fixtures, furniture, and the like (collectively referred to as resources), all of which are subject to potential problems and may need repair from time to time. A person responsible for managing these resources, referred hereto as a user, may have to keep monitoring the functioning of these resources, track their performance parameters, and if something adverse happens, call for help to fix and maintain these resources.

When something breaks or doesn't perform optimally, a user searches typically on the Internet for information on how to fix it, looks for professional services, searches for the places to get the required components or services, and calls them. There are multiple steps involved, and each of these steps has inherent inefficiency. For example, if the user needs help fixing an HVAC system, the user needs to know which component of the system is creating the issue and look for help specifically related to that component. However, most of the time, users will not know the component details and may not even be aware of the brand of installed resources. The existing processes of searching, calling customer support, identifying the service center, navigating to the service center, etc., are fragmented and inefficient ways of maintaining the resources. The user may not know what issue requires what level of attention, whether the issue can be fixed through little educational or do-it-yourself videos, or require expert intervention.

Some existing platforms provide a listing of service person contact details, navigation to the service center, etc. There are video platforms that provide the do-it-yourself type of video, which might be helpful to resolve the issue. However, these platforms are very generic in nature and provide the same results to all the users who search for help on similar topics. A user may spend time viewing several videos and may end up disappointed to find that none of these videos is helpful as the video does not talk specifically about the issue where the user needs help.

Some of these issues are being addressed with changing legal frameworks. For example, a real-estate builder is required to give an instruction manual, warranty papers, etc., to the owner of a property to maintain resources used in the property. However, these manuals are mostly paper booklets and have static content. These instruction manuals get misplaced very often and may not be readily available when required. Even when digitized, their content is static and may not be very useful for users. Different users may have different levels of skills and hence may need a different level of detail or help when they face an issue.

Some attempts have been made in the past to solve some of the related problems discussed above. An example is disclosed in the United States Patent Publication No. 2020/0342421 titled “Home maintenance and repair information technology methods and systems” (the “'421 publication”). The '421 Publication discloses methods and systems for enabling a host provider to provide a consumer homeowner with improved maintenance and repair services for items in the home, including under a subscription model that provides the consumer with predictable cost while assuring reliable services. The '421 Publication discloses an overall information technology system, with interrelated modules and components for enabling a host to facilitate the provision of home maintenance and repair services to a consumer. The methods and systems disclosed herein include an item scoring module for scoring at least one item based on its type, the score based at least in part on a probability of a need for maintenance or repair, and the estimated cost of such maintenance or repair. The system includes a service provider scoring module for scoring at least one service provider based on at least one of the quality of maintenance or repairs provided by the service provider, the availability of the service provider, the reliability of the service provider, and the cost of the service provider, and a pricing module for estimating the cost of providing a commitment to provide long term maintenance and repairs for the at least one scored item using at least one scored service provider. The methods and systems include a consumer communication module, such as facilitating communication to a consumer using various interfaces. The consumer communication module includes a scheduling module, a cost estimation module, a gamification module, and a coordination module. The system further includes a service fulfillment module. In embodiments, the service fulfillment module is used to select a service provider for fulfillment based at least in part on the service provider scoring module. The proposed methods and systems fail to recognize the actual needs of the user and the level of support that the user needs.

Another example solution is disclosed in the United States Patent publication no. 2020/0134752 titled “House Hub” (the “'752 Publication”). The '752 Publication discloses a method and system for providing maintenance services. The system receives user credentials from at least one user, authenticates at least one user based on the user credentials, receives item information related to property from at least one user, generates at least one notification based on at least one item information related to the property, and provides at least one service to the user based on the at least one item information related to the property. The proposed methods and systems fail to recognize the specific needs of the user. Also, the item information needs to be provided by the user.

Another example is disclosed in the United States Patent Publication No. 2011/0270773 titled “Home maintenance recommendation tool” (the “'773 Publication”). The '773 Publication discloses a home maintenance recommendation tool that is incorporated into a user's online financial account. The home maintenance recommendation tool generally provides a user the ability to review, edit, submit, and track home maintenance repairs needed on one or more properties owned by the user. The home maintenance recommendation tool receives information related to repairs that the property might need through the information that is captured when the mortgage is originated, purchased, or serviced, or through purchases made by the user at a business using certain financial accounts. The home maintenance recommendation tool also provides the user the ability to search, identify, receive, and purchase products and services needed to make the suggested repairs through businesses that are strategic partners with the financial institution using the user's online financial account.

All these existing solutions facilitate a user to search, identify, and receive products and services through an online platform. However, none of these systems recognized the specific needs of the user, understood the level of support that a user needs, and provided a personalized information dashboard to manage the resources. The search feature provided is generic, and hence the results displayed are not always useful.

Therefore, there is a need for a method, system, and platform that can understand the maintenance need for resources associated with the entity, enable assisted searching to retrieve the right content, help users get the required level of support, and present personalized content.

The present disclosure makes possible a number of the needed solutions and makes a material and substantial improvement to the current state of the art for understanding maintenance needs for resources associated with the entity, helping the user get the required level of support, and presenting personalized content.

### SUMMARY OF THE INVENTION

Systems, methods, and non-transitory computer-readable mediums for managing resources associated with an entity are described. According to an embodiment, the system monitors real-time resource status associated with each of the one or more resources, identifies at least one action to be performed on a resource of the one or more resources based on analysis of the real-time resource status, generates a context-aware search query related to the at least one action, execute the context-aware search query to retrieve contents associated with the resource, create a personalized recommendation based on retrieved contents, and provide the personalized recommendation to a user for initiating the at least one action. The system includes a centralized database that includes an updated information associated with an entity and one or more resources associated with the entity. The information associated with the entity may include entity type, entity manager data, entity developer data, and a list of resources associated with the entity. The information associated with each resource may include resource type, resource data, service provider data, and content data. The system monitors the resource status using one or more sensors, such as a vibration sensor, a magnetic flux sensor, an ultrasonic acoustic sensor, a strain gauge, a temperature sensor, a proximity sensor, a debris detection sensor, a force and load sensor, a displacement sensor, a position sensor, and an optical sensor.

In an embodiment, the system may initiate the resource status monitoring upon receiving a trigger and/or a command from the user to initiate the monitoring. In an embodiment, the system may automatically initiate the monitoring of the real-time resource status of each of the one or more resource, at predefined intervals of time. Upon receiving the user command or upon rule-based auto-triggering event, the system may collect real-time data, indicative of resource status from the resources. For example, a user may provide instruction through a user interface to monitor or capture present source status using a camera. The system may initiate data collection from different sensors attached to each of the resources. For monitoring different types of resources, different sensors may be required. Based on analysis of the resource status, user profile, semantic understanding of the instruction manuals, and other contexts the system may identify action(s) to be performed.

In an embodiment, the action(s) to be performed on the resource include resolving an issue related to the at least one resource, initiating maintenance of the resource, renewing warranty of the resource, replacing the resource, and upgrading the resource. The system may identify an appropriate action to be performed based on potential fault, actual fault, or for better management and maintenance of the source. The system may use a first machine learning module that has been trained to identify an action that may be performed depending on present resource status, user's preferences, instruction manual associated with the resources, and other contextual information.

In an embodiment, upon identification of the action to be performed, the system may form a context-aware search query or may assist the user to form a context-aware search query to retrieve relevant content. The context-aware search query may include one or more keywords, context tags, resource details, and action details to precisely retrieve the one or more contents. The context-aware query may also include identification of components, bug code (if any), model number, and/or similar other information used to precisely identify the issue. As one may appreciate, in absence of the proposed system, the user had to form his query to get the relevant content, and these queries were most of the time sub-optimal query leading to un-relevant content.

In an embodiment, the context-aware query may include actual resource status, identification of resource, resource details, one or more keywords to describe the resource status, and information about the identified action to be taken. The system may generate the context-aware search query and present to the user. The user may further edit the search query using an interactive response interface. The search query may include voice, text, or image query from the user. In an embodiment, the system may identify the relevant keywords from the user query, and add other context-aware data to form the context-aware query that may be submitted to a search engine. The system may extract and highlight resources that may have created the issue based on other data collected from resources when the user clicks a photo or selects an image. The system may utilize automatically-collected data to highlight the resources that may be facing issue(s) and facilitate the user to select one resource for getting further help. In an embodiment, the system may utilize image processing to identify different resources and highlight one or more resources based on an analyzed anomaly in collected data.

In an embodiment, the system may execute the context-aware search query to retrieve relevant contents associated with the source on which action is to be taken. As the search query is formed with all the relevant context, the retrieved contents are expected to be more relevant. The system may use a second machine learning model to provide personalized recommendation to the user for completing the action. The second machine learning model may utilize metadata of the one or more relevant contents, user profile, and details of at least one action to be performed and generate a personalized recommendation of contents and associated sequence for consumption. For example, if the contents include a few videos, mobile no, do-it-yourself instructions, etc. the second machine learning model may recommend most suitable content and the sequence for the particular user. Some users may prefer to do-it-yourself text instruction, while other users may prefer video showing step-wise action to be taken, yet another user may prefer directly calling the customer care for assistance. Depending on the user profile, action to be taken, and metadata of the contents, the second machine learning model may generate a personalized recommendation of contents to be presented to the user.

In an embodiment, the system may consider user proficiency related to identified issues and present the personalized search results accordingly. The system may provide personalized search results and content (also referred to as recommended content) using a machine learning model that may predict content and metadata that may be useful for resolving the identified issue. The system may train the model with earlier reported issues and useful details associated with the particular users. The system may recommend the content based on the profile match of the user with other users and the identified issue with earlier identified issues in the past. For example, the system for an HVAC related issue may identify the recommended content (e.g., do-it-yourself video, contact detail of service person, instruction manual, etc.) based on historical training on similar content was helpful for other residents in the same community having similar house layout, or house constructed by the same build or using the same service provider.

In an embodiment, the system, through its unified platform, may enable different stack-holders to share information and collaborate in order to maintain the resources. The system may help manage the resources, facilitate users to connect with other entities having similar resources, and facilitate users to connect with product or service companies or individuals who may help resolve any identified issue. The system may enable residents to connect, collaborate, and manage resources efficiently. The system may help present the issue precisely to technicians or engineers working to fix the identified issue. The different stack holders may access the system using the associated user devices online.

In an embodiment, the unified platform may facilitate the users to order components or book services for the identified issue. The platform may present contact details, demo videos, instruction manuals, warranty papers, etc., that the user may need to resolve the identified issue. Instead of presenting all available content, the system may intelligently select the content to present to the user based on the profile of the user and the identified issue.

In an embodiment, the system may facilitate real estate developers to share details of resources, required documents, instruction manuals, and warranties through a single. The new owner may access the list of the resources and associated details through a web-based interface or mobile App. The system may auto-populate the list of resources to the dashboard of a new owner once the property transaction is completed. The system may facilitate the new owner to search the list of resources and associated details by entering property ID. For example, the user may get to know the details on electrical fitting, HVAC systems, appliances, exterior, interior, plumbing, etc., by entering the unique ID of the home.

In an embodiment, the system may recommend content to homeowners specific to their house. The system, through data analysis, may identify the needs of the home and recommend the content to the homeowner. The system may help a homeowner improve and maintain their home faster, and better by qualified industry professionals. The system may facilitate a marketplace where the professional distributor and professional service provider may list associated services for specific home types, resource types, brand, etc. The professional distributor and professional service provider (collectively referred to as Pro distributor) may upload instruction manual, videos, diagnostic steps, etc. The professional distributor or service professional may add, manage, collect, and publish web links. The professional distributor or service professional may bulk upload the contents. The system may classify the uploaded contents and tag the contents with different issues that may be utilized to resolve the issue. The professional distributor or service professional may add associated details against one or more property types (for example, properties developed by a particular real estate developer) or product types. The system may connect the user with the right Pro distributor or service provider.

In an embodiment, the system may auto-categorize the resources into different groups intelligently and present the category options depending on the entity type selected by the user. For example, the broader category for entity type “home” includes HVAC, Appliances, Exterior, Plumbing, Electrical, etc. In proposed system provides a better search experience, presents the best matching content, and provides product and service recommendations. The system may present alerts, tips, events, and special offers useful for maintaining the resources. The system helps the user find the documents, instruction manuals, and contact details of the professional distributor or service professional.

In an embodiment, the system may provide home improvement recommendations to homeowners. The system may provide home improvement recommendations based on the collected data, complementary products and services related to existing products or services, and analysis of user activity on the platform.

In an embodiment, the system may match homeowners to home-specific online content and businesses to improve and maintain the homes faster, and better, with content qualified by industry professionals. Industry professionals may offer solutions to homeowners through the platform. The system may facilitate professionals to maintain personalized pages and Apps through which the professionals may connect with homeowners. The system may facilitate professionals to provide platform branded services or ‘Whitelabel’ services through a standard version of App or a customized App.

Other features of embodiments of the present disclosure will be apparent from the accompanying drawings and detailed description that follows.

### BRIEF DESCRIPTION OF THE DRAWINGS

The present subject matter will now be described in detail with reference to the drawings, which are provided as illustrative examples of the subject matter so as to enable those skilled in the art to practice the subject matter. It will be noted that throughout the appended drawings, features are identified by reference numerals. Notably, the FIGUREs and examples are not meant to limit the scope of the present subject matter to a single embodiment, but other embodiments are possible by way of interchange of some or all of the described or illustrated elements and, further, wherein:

FIG. 1 is a high-level block diagram illustrating a resource management system that supports engagement between different stakeholders, in accordance with an embodiment of the present disclosure.

FIG. 2A illustrates a block diagram of the resource management system, in accordance with an embodiment of the present disclosure.

FIG. 2B illustrates exemplary working of functional module and data flow between modules of the resource management system, in accordance with an embodiment of the present disclosure.

FIG. 3A illustrates an exemplary entity-specific user interface, in accordance with an embodiment of the present disclosure.

FIG. 3B illustrates an example professional distributor interface designed, in accordance with an embodiment of the present disclosure.

FIG. 4 illustrates an example process flow enabling a user to select a resource and connect with the right person or business, in accordance with an embodiment of the present disclosure.

FIG. 5 illustrates functional blocks of the searching module designed to enable context-aware search query formation and retrieval of recommended content in accordance with an embodiment of the present disclosure.

FIG. 6 is an exemplary block diagram illustrating an image-based search feature in accordance with an embodiment of the present disclosure.

FIG. 7 is an exemplary block diagram illustrating text or voice-based search feature in accordance with an embodiment of the present disclosure.

FIG. 8 illustrates an example feature list offered through a mobile application by the system to a user in accordance with an embodiment of the present disclosure.

FIG. 9 is a flow diagram illustrating image-based interaction with the system in accordance with an embodiment of the present disclosure.

FIG. 10A is an example user interface illustrating a landing page for a mobile application in accordance with an embodiment of the present disclosure.

FIG. 10B is an example user interface illustrating categories for selected entity types in accordance with an embodiment of the present disclosure.

FIG. 10C is an example user interface illustrating a sub-category of resources inbyn embodiment of the present disclosure.

FIG. 10D is an example user interface illustrating item types associated with a resource that a user may browse in accordance with an embodiment of the present disclosure.

FIG. 11A-11C are example user interfaces illustrating different content types that may be shown to the user in accordance with an embodiment of the present disclosure.

FIG. 12A-C are example user interfaces used to add details associated with a resource in accordance with an embodiment of the present disclosure.

FIG. 13 illustrates an exemplary computer system in which or with which embodiments of the present invention may be utilized.

### DETAILED DESCRIPTION OF THE PREFERRED EMBODIMENT

The detailed description set forth below in connection with the appended drawings is intended as a description of exemplary embodiments in which the presently disclosed process can be practiced. The term “exemplary” used throughout this description means “serving as an example, instance, or illustration” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form in order to avoid obscuring the concepts of the presently disclosed method and system.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and human operators.

Embodiments of the present invention may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within the single computer) and storage systems containing or having network access to a computer program(s) coded in accordance with various methods described herein, and the method steps of the invention could be accomplished by modules, routines, subroutines, or subparts of a computer program product.

The terms “connected” or “coupled” and related terms are used in an operational sense and are not necessarily limited to a direct connection or coupling. Thus, for example, two devices may be coupled directly or via one or more intermediary media or devices. As another example, devices may be coupled in such a way that information can be passed therebetween while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

As used herein, a “network resource” generally refers to various forms of data, information, services, applications, and/or hardware devices that may be accessed via a network (e.g., the Internet). Non-limiting examples of network resources include web applications, cloud-based services, networked devices and/or associated applications (e.g., user interface applications), and network security devices and/or associated applications (e.g., user interface applications). Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Systems, methods, and non-transitory computer-readable mediums for managing resources associated with an entity are described. According to an embodiment, the system monitors real-time resource status associated with each of the one or more resources, identifies at least one action to be performed on a resource of the one or more resources based on analysis of the real-time resource status, generates a context-aware search query related to the at least one action, execute the context-aware search query to retrieve contents associated with the resource, create a personalized recommendation based on retrieved contents, and provide the personalized recommendation to a user for initiating the at least one action. The system includes a centralized database that keeps an updated information associated with an entity and one or more resources associated with the entity. The information associated with the entity may include entity type, entity manager data, entity developer data, and a list of resources associated with the entity. The information associated with each resource may include resource type, resource data, service provider data, and content data. The system monitors the resource status using one or more sensors, such as a vibration sensor, a magnetic flux sensor, an ultrasonic acoustic sensor, a strain gauge, a temperature sensor, a proximity sensor, a debris detection sensor, a force and load sensor, a displacement sensor, a position sensor, and an optical sensor.

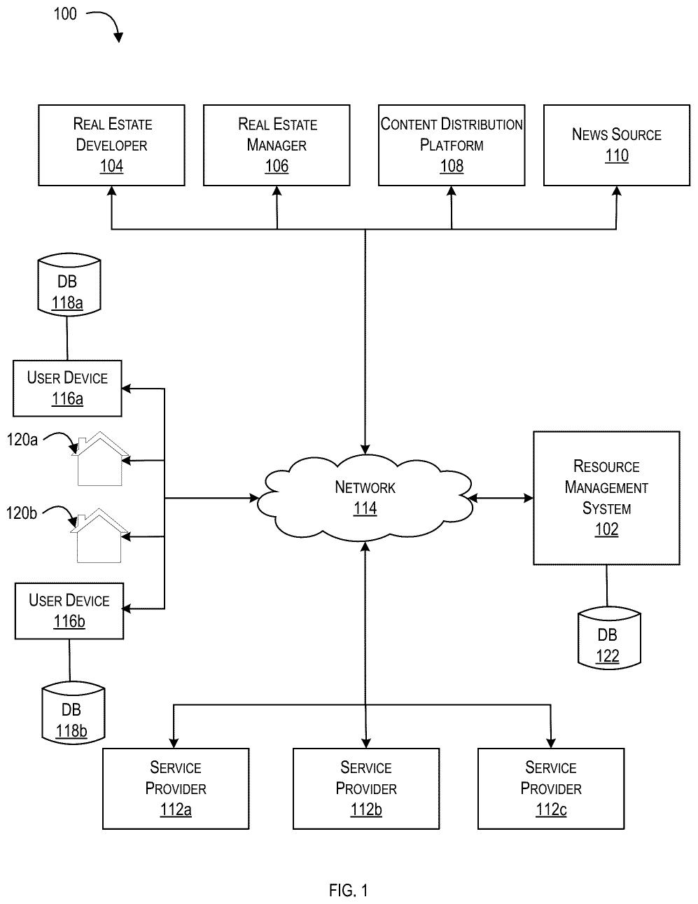

FIG. 1 is a high-level block diagram 100 illustrating a resource management system that supports engagement between different stakeholders in accordance with an embodiment of the present disclosure. In an embodiment, the resource management system 102 (herewith also termed as system 102) may maintain a central database (e.g., DB 122) or use cloud storage to store a profile of entities (e.g., individual user, home, community, company, etc.), service providers, original equipment manufacturers, real-real developers, etc. and enable interaction between different stakeholders when needed. The system 102 may maintain a list of resources associated with each entity (e.g., home 120a, home 120b, individual, community, company, etc.). A user using a user device (e.g., user device 116a, and user device 116b) may connect with the resource management system 102 through network 114. A user using a mobile application or web-based interface may search with an entity identification number (e.g., house number, society registration number, SSN, etc.) and get details of all resources associated with an entity. The system 102 may facilitate an application running on a user device to store details associated with the resources on a local database (e.g., DB 118a associated with user device 116a and DB 118b associated with user device 116b) for better privacy protection or may store the list of resources belonging to an entity in a central database 122 or cloud-based database.

In an embodiment, the system 102 may not require the users to disclose any personally identifiable information to sign up. The system 102 may support target ads on aggregate trends in interactions based on the home profile, as well as the community as a whole, but not the individual user. By default, saved information may be stored only specific to the device and may be saved to the device using a local database. The device-saved information may facilitate even children to contribute anonymously and effectively. The users may access the system using a home ID specific to the home, not the resident. The users may add and save private content items by saving the private content in a device-specific local database (Local Storage) for later retrieval. The device-shaped private content items may facilitate the users to save a reference to favorite items without having to sign up or save items to the web. Further, saving private content items may safely facilitate all ages to use them. The users may share an individual item or a filtered list of items, including favorites.

In an embodiment, the user may provide an entity identification number, authenticate to access resource details associated with the entity, and access the list of resources once authenticated. The system 102 may present a list of resources associated with the entity, working status of resources, data collected from Internet-enabled resources, and analyze the collected data to identify a potential issue. The system 102 may perform predictive diagnostics on all resources regularly or perform resource-specific diagnostics at request of the user. The user may browse through the list of resources associated with an entity and select a resource to get more details. The list of resources associated with the entity may be bulk uploaded through a smart script or may be uploaded through a web-based or mobile application interface. In an embodiment, a new resource may automatically be associated with an entity when purchase and installation are confirmed. For example, a new appliance may be added to the list of resources associated with a home when the purchase and installation at home are confirmed.

In an embodiment, the system 102 may facilitate different stakeholders to post content related to different resources, tag the posted content appropriately, and upload the posted content for access by other users. The different stakeholders may include end-users, homeowners, real estate developers 104, real estate manager 106, content developers, news resources 110, service providers 112a-n, original equipment manufacturers (OEMs), authorized distributors, authorized service centers, and the like. The uploaded content may be stored in database DB 122 managed by the system 102 or be uploaded to content distribution platform 108. In an embodiment, the system 102 may store raw media files on the content distribution platforms (e.g., YouTube) for memory optimization and keep the manifest file or the metadata information on the location DB 122.

In an embodiment, the system 102 may enable the transfer of access rights to get details on the list of resources associated with a home (e.g., home 120a) once the real-estate developer 104 sells the home to a new homeowner. The Dashboard board of the homeowner may auto-populate the list of resources associated with the home. The homeowner may browse through the list of resources and select a resource to get details, such as OEM, brand, model number, purchase date, installation date, working status, warranty document, next service due date, etc.

In an embodiment, the system 102 may regularly collect data on the working status of each of the resources and perform a diagnosis to identify a potential issue with the resource. The system 102 may assist the user in forming a context-aware search query related to the potential issue, retrieve a set of contents, and provide personalized results suitable for maintaining the resource.

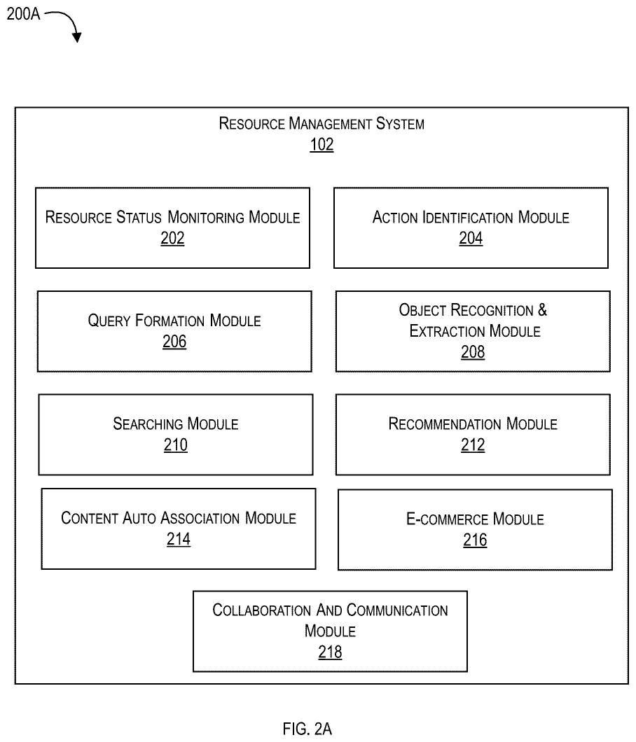

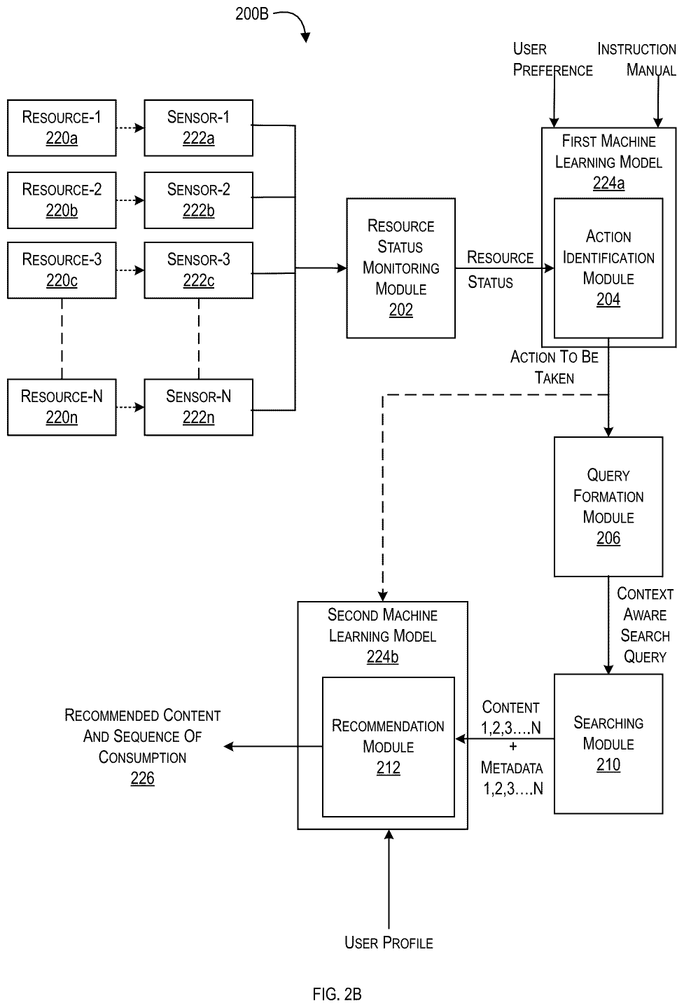

FIG. 2 illustrates a block diagram 200A of the resource management system 102 in accordance with an embodiment of the present disclosure. The resource management system 102 may include a resource status monitoring module 202 to monitor and/or collect logs and working status data from Internet-enabled resources. The resource status monitoring module 202 may help retrieve identification details of a new resource associated with an entity and collect metadata from public sources, warranty certificates from the seller, and annotate content using different Application Program Interfaces (APIs). The resource status monitoring module 202 may monitor the resource status through a push or pull mechanism log data and working status data and bug code (if any generated) from resources through a wireless or wired interface.

In an embodiment, the system 102 may include an action identification module 204 to identify action(s) to be performed on one resource amongst the one or more resources, based on corresponding real-time resource status. The real-time resource status may include various parameters such as operational efficiency, wear and tear, performance deviations, or any potential issues detected by the system 102. Based on real-time resource status, the action identification module 204 may generate an appropriate action recommendation, ensuring timely intervention for the efficient management of the resource.

In an embodiment, the identified action may include, but is not limited to, maintenance tasks, component replacement, resource upgrades, or the initiation of corrective measures to address detected issues. The action identification module 204 may leverage predefined thresholds and historical resource data to evaluate whether the identified action is necessary. The action identification module 204 may account for external factors such as service schedules, resource utilization patterns, instruction manuals, and user preferences to ensure that the identified action align with the operational requirements and overall management strategy of the entity.

In an embodiment, the action identification module 204 may further integrate with external systems or service providers to automatically schedule necessary actions. For instance, upon identifying a need for maintenance, the system 102 may generate a service request, communicate with a relevant service provider, and provide the user with a scheduled maintenance recommendation.

In an embodiment, the system 102 may include a query formation module 206 to generate context-aware queries when the user needs help to manage or improve resources. The module 206 may assist the user with the context-aware search query based on collected data or reported data. The context-aware search query may include identification of components, bug code (if any), model number, and similar other information used to precisely identify the issue. In an embodiment, module 206 may help the user form a context-aware query or add context to a query submitted by the user automatically based on the collected data about the issue. The query formation module 206 may receive voice, text, or image query from the user, identify the relevant keywords from the user query, and add other context-aware data to form the context-aware query that may be submitted to a search engine. The query formation module 206 may also receive the image-based search request.

In an embodiment, the module 206 may work with object recognition and extraction module 208 to perform image analysis, detect an object, and extract objects for performing the search. Module 208 may provide text or an extracted object that may be used for searching. The query formation module 206 may help select an object from a list of objects recognized by module 208. For example, the query formation module 206 may pass information to the image analysis engine to bias itself to recognize resources for which collected data shows some anomaly. The Module 208 may help to select an object and highlight one or more resources that may have created the issue based on other data collected from resources when a user clicks a photo or selects an image. The module 208 may utilize the collected data to highlight one or more resources that may be facing an issue and facilitate the user to select one resource for getting further help. The object recognition and extraction module 208 utilizes image processing to identify different resources and highlight one or more resources based on analyzed anomaly in collected data.

In an embodiment, the system 102 may include a searching module 210 to receive the context-aware search query to identify matching results. The searching module 210 may submit the context-aware query for one or more search engines to its internal database. The searching module 210 may retrieve a list of matching results and pass the results summary and annotated data to recommendation module 212. The recommendation module 212 may utilize user proficiency related to identified issues and present the personalized search results accordingly. In an embodiment, the recommendation module 212 may provide personalized search results and content (also referred to as recommended content) using a machine learning model that may predict content and metadata that may be useful for resolving the identified issue. The module 212 may utilize a machine-learning model to resolve the identified issue. The machine learning model may be trained with earlier reported issues and useful details associated with associated reported issues. The recommendation module 212 may recommend the content based on profile match of the user with other users and identify an issue with earlier identified issues in the past. For example, the recommendation module 212, for an HVAC related issue, may identify the recommended content (e.g., do-it-yourself video, contact detail of service person, instruction manual, etc.) based on successful historical training for other residents in the same community having similar house layout, or house constructed by the same build or using the same service provider.

In an embodiment, the system 102, through a unified online platform, may enable different stack-holders to share information and collaborate in order to maintain the resources. The system 102 may help manage the resources, facilitate the users to connect with other entities having similar resources, and facilitate the users to connect with product or service companies or individuals that may help resolve the identified issue. The system 102 may enable residents to connect, collaborate, and manage resources efficiently. The system 102 may help present the issue precisely to technicians or engineers working to fix the identified issue. Different stack holders may access the system 102 using user devices online.

In an embodiment, the platform may enable the residents and residential communities to connect with resources to improve and manage homes, environment, and lifestyle. The platform may facilitate distributors to leverage the local community, residents, and local businesses to contribute ecosystem of the system-supported apps. The platform may enable referrals to local entertainment, news & activities.

In an embodiment, the system 102 may improve the community as a whole by offering interactive tools that help educate, communicate, and collaborate. In an embodiment, the system 102 may utilize web technologies to manage and prefilter content submitted by different users. In an embodiment, the system 102 may support multiple options to find content, including a general menu. The general menu may include links to categories for each main feature of the home, along with its corresponding sub-features.

In an embodiment, the unified platform may facilitate users to order components or book services for the identified issue. The platform may present contact details, demo videos, instruction manuals, warranty papers, etc., that the user may need to resolve the identified issue. In an embodiment, instead of presenting all available content, the system 102 may intelligently select the content to present to the user based on the profile of the user and the identified issue.

In an embodiment, the system 102 may facilitate real estate developers to share details of resources, required documents, instruction manuals, and warranties through a single. The new owner may access the list of the resources and associated details through a web-based interface or mobile App. In an embodiment, the system 102 may auto-populate the list of resources to the dashboard of a new owner when the property transaction is completed. The system 102 may facilitate the new owner to search the list of resources and associated details by entering property ID. For example, a user may get to know the details on electrical fitting, HVAC systems, appliances, exterior, interior, plumbing, etc., by entering the unique ID of the home. The system 102 may be accessed through a website, web widget on affiliate websites, or integrated into a downloadable app of a mobile device.

In an embodiment, the system 202 may include a content auto association module 214 to collect content associated with any resources that are submitted on different content distribution or social media platforms. Once a suitable content match is found, the auto association module 214 may tag the content match with the right resource. For example, if the content is posted on fixing a refrigerator, the content auto association module 214 may analyze the posted content to identify the brand and model and tag the content with that refrigerator model. All the homeowners who have the same refrigerator model may see the new content. The newly added content may be recommended to a user who is facing a similar issue being addressed in the content.

In an embodiment, the system 102 may include an eCommerce module 216 that recommends content to homeowners specific to their homes. The module 216, through data analysis, may identify the needs of the home and recommend the content to the homeowner. The system 102 may help a homeowner improve and maintain associated homes faster, and better by qualified industry professionals. The system 102 may provide home improvement recommendations to homeowners. The system 102 may provide home improvement recommendations based on the collected data, complementary products and services related to existing products or services, and analysis of user activity on the platform.

In an embodiment, the system 102 may facilitate a marketplace where the professional distributor and professional service provider may list their services for specific home types, resource types, brand, etc. The professional distributor and professional service provider (collectively referred to as Pro distributor) may upload instruction manual, videos, diagnostic steps, etc. The professional distributor or service professional may add, manage, collect, and publish web links. The professional distributor or service professional may bulk upload the contents, which the system 102 may classify may tag with different issues that it may help resolve. The professional distributor or service professional may add his details against one or more property types (for example, properties developed by a particular real estate developer) or product types. The system may connect the user with the right Pro distributor or service provider.

In an embodiment, the system 102 may auto-categorize the resources into different groups intelligently and present the category options depending on the entity type selected by the user. For example, the broader category for entity type “home” includes HVAC, Appliances, Exterior, Plumbing, Electrical, etc. The system 102 provides a better searching experience, presents the best matching content, and provides product and service recommendations. In an embodiment, the system 102 may present alerts, tips, events, and special offers useful for maintaining the resources. The system helps the user easily find the documents, instruction manuals, and contact details of the professional distributor or service professional.

In an embodiment, the system 102 may include a collaboration and communication module 218 to facilitate the different stack holders to collaborate and communicate on some common issues. For example, module 218 may connect user A and user B, who may be facing a similar issue, and further connect them to a service person. The module 218 may enable collaboration and communication to bring stakeholders on a single platform. For example, the module 218 may enable collaboration and communication between real-estate builders, homeowners, service providers, community managers, etc.

In an embodiment, the system 102 may facilitate residents of a community to share ideas with others and report issues. In an embodiment, the system 102 may reward users who report a valid issue and post a useful solution that might be useful for others.

FIG. 2B illustrates exemplary working of functional module and data flow between modules of the resource management system, in accordance with an embodiment of the present disclosure. In an embodiment, the system 102 may monitor real-time resource status, identify necessary actions based on the corresponding resource status, generate context-aware search queries, and provide personalized recommendations. In an embodiment, the resource status monitoring module 202 may monitor the status of resource-1 220a, resource-2 220b, resource-3 220c, resource-N 220n (henceforth also termed as resource 220) via sensors 222a, 222b, 222c, 222n (henceforth also termed as sensors 222). The sensors 222 may include a variety of sensors such as a vibration sensor, a magnetic flux sensor, an ultrasonic acoustic sensor, a strain gauge, a temperature sensor, a proximity sensor, a debris detection sensor, a force and load sensor, a displacement sensor, a position sensor, an optical sensor others. The resource status monitoring 202 may evaluate the real-time operational status of each resource 220 by analyzing data provided by the sensors 222. For example, for resource 220, data from sensor 222 might indicate a decrease in performance due to excessive vibrations, prompting further analysis. Similarly, each sensor associated with a specific resource may continually provide real-time updates on key operational parameters of the resource 220.

In an embodiment, the resource status monitoring module 202 may automatically initiate the monitoring of the real-time resource status of each of the one or more resource, at predefined intervals of time. Upon receiving the user command or upon rule-based auto-triggering event, the resource status monitoring module 202 may collect real-time data, indicative of resource status from the resources. For example, a user may provide instruction through a user interface to monitor or capture present source status using a camera. The resource status monitoring module 202 may initiate data collection from different sensors attached to each of the resources. For monitoring different types of resources, different sensors may be required. Based on analysis of the resource status, user profile, semantic understanding of the instruction manuals, and other contexts the system may identify action(s) to be performed.

In an embodiment, the action identification module 204 may analyze the data from the sensors 222 and identify one or more actions to be performed on a particular resource. The action identification module 204 may utilize a combination of predefined rules, thresholds, user preference, instruction manual, and machine learning model 224a to determine whether maintenance, upgrades, or other corrective actions are required for the respective resource 220. For example, if the sensor data from resource 220 indicate an anomaly such as temperature fluctuations outside normal operating ranges, the action identification module 204 may recommend immediate maintenance to prevent failure of the resource. In an embodiment, the identified action may include resolving an issue related to the resource 220, initiating maintenance of the resource 220, renewing warranty of the resource 220, replacing the resource 220, and/or upgrading the resource 220.

In an embodiment, based on analysis of the resource status, user profile, semantic understanding of the instruction manuals, and other contexts the action identification module 204 may identify action(s) to be performed. The action(s) to be performed on the resource include resolving an issue related to the at least one resource, initiating maintenance of the resource, renewing warranty of the resource, replacing the resource, and upgrading the resource. The action identification module 204 may identify an appropriate action to be performed based on potential fault, actual fault, or for better management and maintenance of the source. The action identification module 204 may use a first machine learning module that has been trained to identify an action that may be performed depending on present resource status, user's preferences, instruction manual associated with the resources, and other contextual information.

In an embodiment, the query formation module 206 may generate a context-aware search query based on the identified action, the real-time resource status, and relevant resource metadata. The query formation module 206 may incorporate resource details, action details, and additional contextual information to ensure the query is precise and accurate. For instance, the query may include specific keywords such as “maintenance,” “temperature anomaly,” etc. to retrieve content related to resolving the detected issue. In an embodiment, the context-aware search query may include one or more keywords, context tags, resource details, and action details to precisely retrieve relevant content. In an embodiment, generating the context-aware search query includes receiving real-time inputs from the user to update the context-ware search query.

In an embodiment, the context-aware query may include actual resource status, identification of resource, resource details, one or more keywords to describe the resource status, and information about the identified action to be taken. The query formation module 206 may generate the context-aware search query and present to the user. The user may further edit the search query using an interactive response interface. The search query may include voice, text, or image query from the user. In an embodiment, the system may identify the relevant keywords from the user query, and add other context-aware data to form the context-aware query that may be submitted to a search engine. The query formation module 206 may extract and highlight resources that may have created the issue based on other data collected from resources when the user clicks a photo or selects an image. The query formation module 206 may utilize automatically-collected data to highlight the resources that may be facing issue(s) and facilitate the user to select one resource for getting further help. In an embodiment, the query formation module 206 may utilize image processing to identify different resources and highlight one or more resources based on an analyzed anomaly in collected data.

In an embodiment, the searching module 210 may execute the context-aware search query to retrieve relevant content, such as instruction manuals, user guides, or troubleshooting documentation. The searching module may also provide metadata associated with the query. In an embodiment, the searching module 210 may optimize the search results by understanding the context of the query and ranking the results based on relevancy to the identified action. The searching module 210 may also utilize natural language processing (NLP) techniques to refine the query results and ensure that the content retrieved aligns with the specific needs of the resource in question.

In an embodiment, the searching module 210 may execute the context-aware search query to retrieve relevant contents associated with the source on which action is to be taken. As the search query is formed with all the relevant context, the retrieved contents are expected to be more relevant.

In an embodiment, the retrieved content may be processed by the recommendation module 212 to analyze the search results and recommend content and sequence of consumption 226 for actions to be taken on the resource. The recommendation module 212 may utilize a (second) machine learning model 224b for providing recommendations. The recommendation module 212 may utilize user profile to tailor the recommendations. The user profile may include user preferences, historical data, and usage patterns. For example, if the system 102 has previously recommended maintenance for a similar issue on resource 220c, the recommendation module 212 might prioritize similar actions for resource 220b. In an embodiment, the recommendation module 212 may utilize metadata and other contextual elements, provided by the searching module 210, to suggest the sequence of actions or content consumption, streamlining the user's decision-making process.

In an embodiment, the recommendation module 212 may utilize the action identified by the action identification module 204 to generate one or more personalized recommendations for the user. The recommendations may be based on the real-time resource status and the specific action to be taken, ensuring that the user receives targeted guidance tailored to the needs of the resource. For instance, if the action identification module 204 detects that a resource requires maintenance, the recommendation module 212 may suggest an optimal time for performing the maintenance, recommend a relevant service provider, or provide step-by-step instructions for executing the maintenance task. In an embodiment, the recommendation module 212 may consider the combination of retrieved content, retrieved metadata, user profile, and identified action to refine the recommendations.

In an embodiment, the recommendation module 212 may provide a sequence to the order in which recommended actions should be taken. The sequencing may be determined based on the urgency of the action, the resource 220 operational importance, and any dependencies between multiple actions. The recommendation module 212 may, for instance, recommend resolving a critical issue before suggesting routine maintenance tasks, thus optimizing resource management and ensuring efficient operation.

The recommendation module 212 may utilize the second machine learning model 224b to provide personalized recommendation to the user for completing the action. The second machine learning model 224b may utilize metadata of the one or more relevant contents, user profile, and details of at least one action to be performed and generate a personalized recommendation of contents and associated sequence for consumption. For example, if the contents include a few videos, mobile no, do-it-yourself instructions, etc. the second machine learning model 224b may recommend most suitable content and the sequence for the particular user. Some users may prefer to do-it-yourself text instruction, while other users may prefer video showing step-wise action to be taken, yet another user may prefer directly calling the customer care for assistance. Depending on the user profile, action to be taken, and metadata of the contents, the second machine learning model 224b may generate a personalized recommendation of contents to be presented to the user.

In an embodiment, the recommendation module 212 may consider user proficiency related to identified issues and present the personalized search results accordingly. The recommendation module 212 may provide personalized search results and content (also referred to as recommended content) using the machine learning model 224b that may utilize content and metadata useful for resolving the identified issue. The system 102 may train the model with earlier reported issues and useful details associated with the particular users. The recommendation module 212 may recommend the content based on the profile match of the user with other users and the identified issue with earlier identified issues in the past. For example, the system for an HVAC related issue may identify the recommended content (e.g., do-it-yourself video, contact detail of service person, instruction manual, etc.) based on historical training on similar content was helpful for other residents in the same community having similar house layout, or house constructed by the same build or using the same service provider.

In an embodiment, the system 102 may continue learning and improve recommendations through feedback loops facilitated by the machine learning models 224a and 224b. The ML models may continuously refine the understanding of user preferences, resource behavior, and contextual factors, to generate accurate and timely recommendations for resource management.

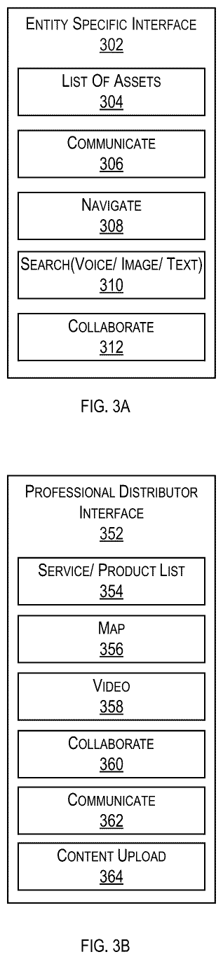

FIG. 3A illustrates an exemplary entity-specific user interface 302 in accordance with an embodiment of the present disclosure. The system 102 may facilitate stakeholders to connect through custom interfaces. For example, different interfaces for a homeowner, professional distributor, or service provider may be provided. The entity-specific interface 302 is an example interface that enables a homeowner to perform different functions enabled by the system. The interface 302 presents a list of resources associated with an entity when the user selects option “list of assets 304” (interchangeably referred to as resources). The interface may facilitate the user to communicate with other stakeholders by selecting the option “communicate 306”. On selecting communicate 306 option, the system 102 may connect the user with the right person who may help the user solve the issue at hand. The system 102 may intelligently select a person who may help the user based on predictive analysis of the issue being faced. Depending on the level of expertise needed to solve the issue, the system 102 may connect the user to the right person. The user may choose the option “navigate 308” to navigate to the nearest professional distributor or service provider. The user may select the “search 310” option to get help on any issue. As described earlier, on the selection of search options, the system helps the user build context-aware search queries. The interface 302 further includes an option to collaborate 312 that facilitates different stakeholders to share information and collaborate to collectively solve an issue at hand.

FIG. 3B illustrates an example professional distributor interface 352 designed in accordance with an embodiment of the present disclosure. The professional distributor interface 352 is an example interface presented to a professional distributor. In an embodiment, the interface 352 may facilitate the professional distributor to see and update service/product list 354 for which he/she is an expert. The professional distributor may select option “map 356” to update or share location or navigate to the user location from where the issue has been reported. The professional distributor may add/add video related to a resource (product or service) by selecting option “video 358”. The interface may include options to collaborate 360 and communicate 362 that facilitate the professional distributor to collaborate and communicate with other stakeholders. The professional distributor interface 352 may include the option of “content upload 364,” which facilitates content with annotation/metadata. The annotation or metadata may help search engines present the matching content to the users.

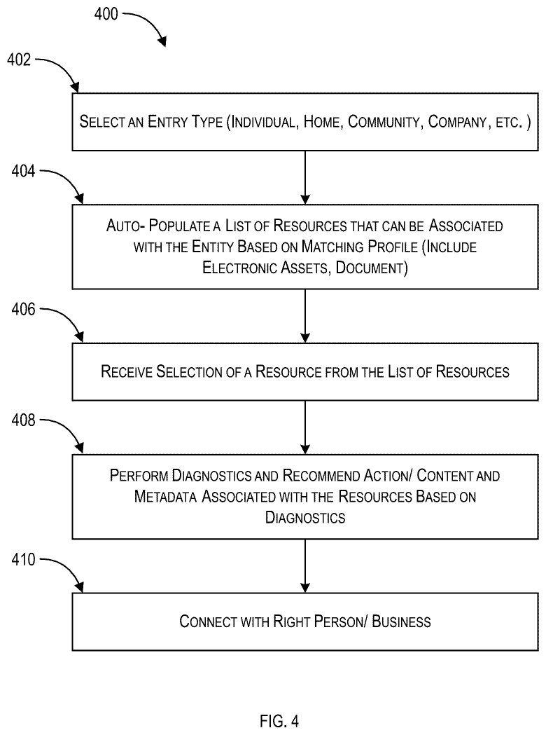

FIG. 4 illustrates an example process 400 flow enabling a user to select a resource-creating issue and connect with the right person or business in accordance with an embodiment of the present disclosure. Process 400 may include steps of enabling a user to select an entity type through an application interface, as shown in block 402. The user, through an application interface or web-based interface, may connect to an online resource management platform. The user may select an entity type from a list of entity types, which include individual, home, community, company, etc., and enter an entity identification number. On entering the entity identification, the user may be promoted to validate its identity if the preconfigured setting of the entity requires so. Process 404 may include steps of auto-populating, by the online resource management platform, a list of resources that may be associated with the entity based on matching profile, as shown at block 404, and enabling the user to select one or more resources from a list of auto-populated resources that the user wishes to manage or improve, as shown at block 406. Process 400 may include steps of performing diagnostics and recommending action, content, and/or metadata associated with resources based on diagnostics, as shown in block 408, and connecting the user with the right person or business as shown in block 410. The user may seek help on any specific resource. To get help, the user may search for relevant content on the web, which may be a time-consuming activity. The platform may enable the user to perform context-aware searches using text, voice, or image.

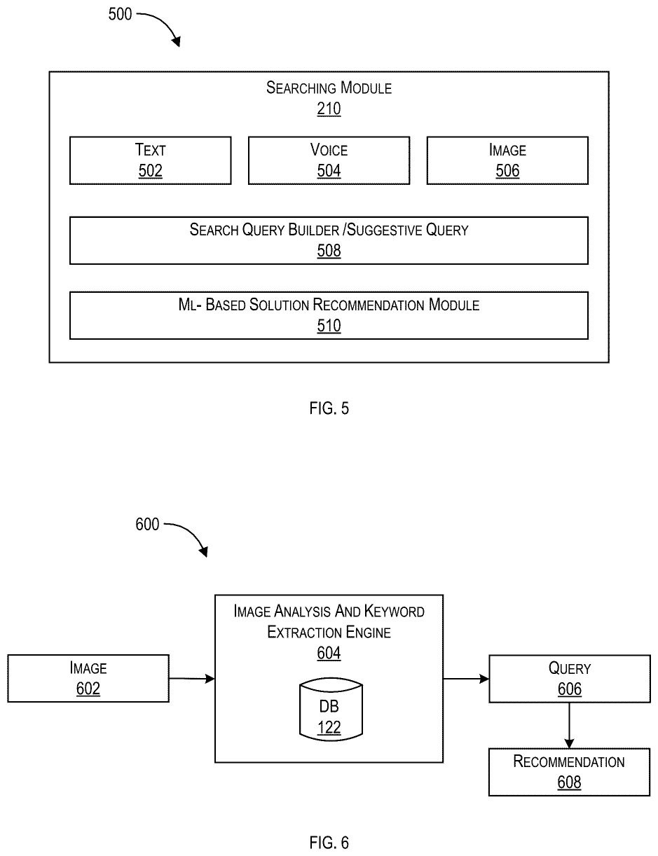

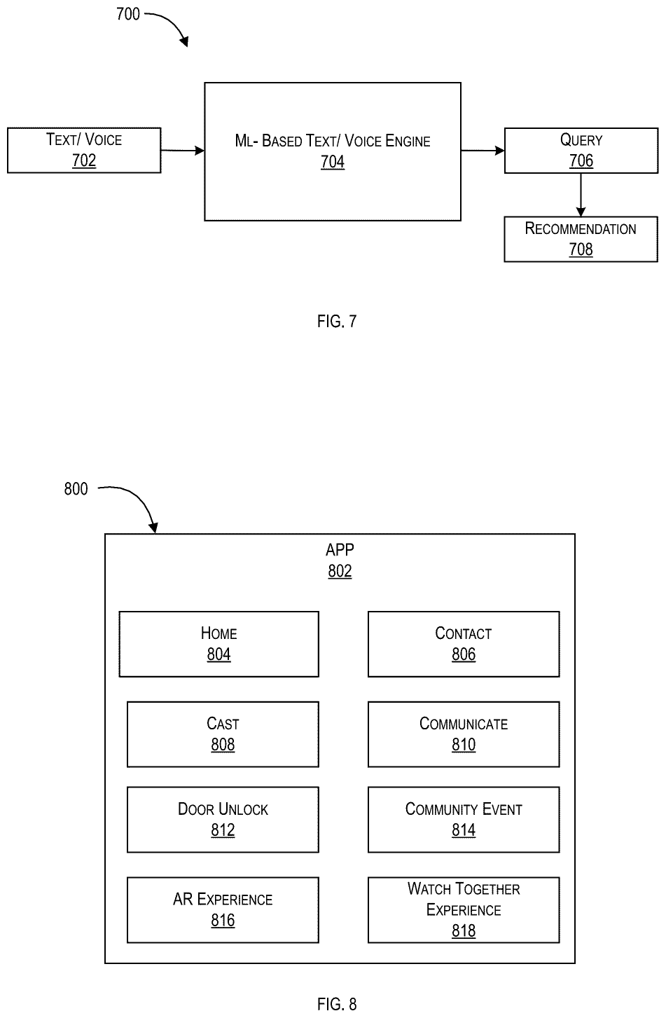

FIG. 5 illustrates functional blocks 500 of the searching module designed to enable context-aware search query formation and retrieval of recommended content in accordance with an embodiment of the present disclosure. The searching module 210 may facilitate the users to perform different types of searches, including text 502, voice 504, and image 506. The searching module 210 may receive any or combination of text, voice, and image as input and helps to build context-aware search queries. The searching module 210 may add context to the query based on the data collected from resources. In an embodiment, a search query builder/suggestive query module 508 may facilitate the user to build a context-aware query or provide suggestive query based on user-entered search parameters and data collected from resources. Processing of different types of searches is described later with reference to FIG. 6 and FIG. 7. In an embodiment, an ML-based solution recommendation module 510 may recommend the best solution and content to the user using a machine learning (ML) model. The module 510 may present the recommended solution and content to a user-based submitted context-aware query and the profile of the user. The module 510 may consider the type of solutions that were helpful for other users having matching profiles for similar situations/issues.

In an embodiment, the searching module 210 may help users query a centralized database of linked content and anonymized resident reviews. The ML model may help make predictions of the issue and suitable solutions over time as more data gets added. The ML model may be trained with data related to more home types, resources, user profiles, contents, issues, and solutions.

In an embodiment, the user may submit a query in numerous ways. FIG. 6 is an exemplary block diagram 600 illustrating an image-based search feature in accordance with an embodiment of the present disclosure. In an embodiment, the user may submit a query in form of image 602, as shown in FIG. 6. The image 602 may be processed by image analysis and keyword extraction engine 604. The engine 604 may refer to local DB 122 or a public database for recognizing the objects (resources). The engine 604 may be an AI-based object recognition system to identify faulty objects. The engine may extract prominent characteristics of the image in the form of keywords which are used to generate search query 606. The search query 606 may be submitted in raw form or may be enhanced to add context-awareness. Based on the query submitted, the searching module 210 may provide recommended set of results. FIG. 7 is an exemplary block diagram 700 illustrating text or voice-based search feature in accordance with an embodiment of the present disclosure. In an embodiment, the user may alternatively submit text or voice 702 input that may be processed by ML-based text/voice search engine 704. The engine 704 may process the voice input using a combination of automatic speech recognition engines and natural language processing engines and create. The search query 708 may be submitted in raw form or may be enhanced to add context-awareness. Based on the query submitted, the searching module 210 may provide the recommended set of results. The searching module 210 may provide the best-weighted search for the given home model, home interests, and resident rating.

In an embodiment, the users may also utilize a text/voice-based search function using natural language. The system 102 may use Microsoft Azure AI speech, vision, and language services to transform raw, unstructured information into searchable content. Azure Cognitive Search may facilitate the searching module to select important keywords from the user's input to be used in conjunction with other search functions.

FIG. 8 illustrates an example feature list offered through a mobile application 800 by the system 102 to the user in accordance with an embodiment of the present disclosure. In an embodiment, the system 102 may facilitate users to connect through mobile Applications (APP) 802. In an embodiment, interface 800 of the APP 802 may include options, such as home 804, contacts 806, cast 808, communicate 810, door unlock 812, community event 814, AR experience 816, and watch together experience 818. The home 804 may present resources associated with a home. The contacts 806 option may present contact details of different vendors categorized on the logical grouping and potential issue-wise. The cast 808 option may facilitate the user to cast the screen to another detail so that others may see the issue, recommended solution, content, etc. The communicate 810 option may facilitate users to communicate with a professional service provider or other users facing similar issues. The door unlocks 812 option may facilitate the user to unlock the door from a remote location. The door unlock 812 option may be used by the user in a situation where something needs to be fixed (e.g., a plumbing issue) in a home, but the user is not at home. The community event 814 may be used to create and participate in a community event. The community event 814 may be used to report an issue, which may have an impact on other homes having a similar profile or in the vicinity. The AR experience 816 may facilitate different stakeholders (homeowner, real estate builder, service professional, etc.) to watch the issue and contents together. Using a QR code or smart tag, users may search for an item and initiate an AR experience. In an embodiment, the system 102 may add other stakeholders or send an invite to join the AR experience to explore the issue and help the user resolve the issue. The QR codes and NFC tags may be associated with important resources within the home as well as the community for easy access to content regarding tips, resources, and related contacts. The user may use phone to take a picture, smay, or tap (NFC) to reveal Content. The user may take a picture, smay, or tap the NFC tag to get details of a home or home resources. The tags may be attached within a home or on specific item(s) of a home. Similarly, the watch together experiences 818 may facilitate the user and other stack holders to watch the issue in a 2D, 3D, or 360-degree environment.

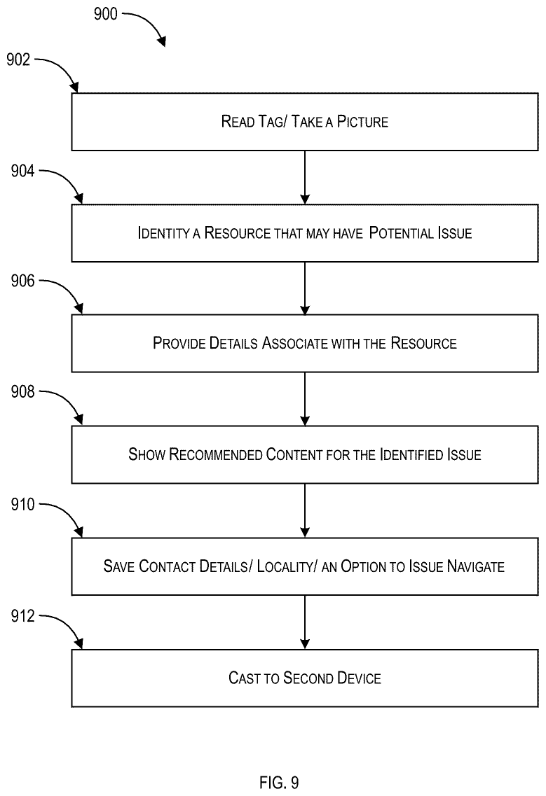

FIG. 9 is a flow diagram 900 illustrating image-based interaction with the system 102 in accordance with an embodiment of the present disclosure. In an embodiment, the user may take a picture or read a tag associated with an item (here forth also referred to as resource), as shown in block 902. The system 102 may identify the resource that may have a potential issue from the smayned tag/picture, as shown at block 904, provide details associated with the resources as shown at block 906, show recommended content for the identified issue as shown at block 908, and facilitates user to save contact details/locality of the service professional or an option to navigate to professional service address as shown at block 910. The system 102 may facilitate the users to cast his/her screen on the second device, as shown in block 912.

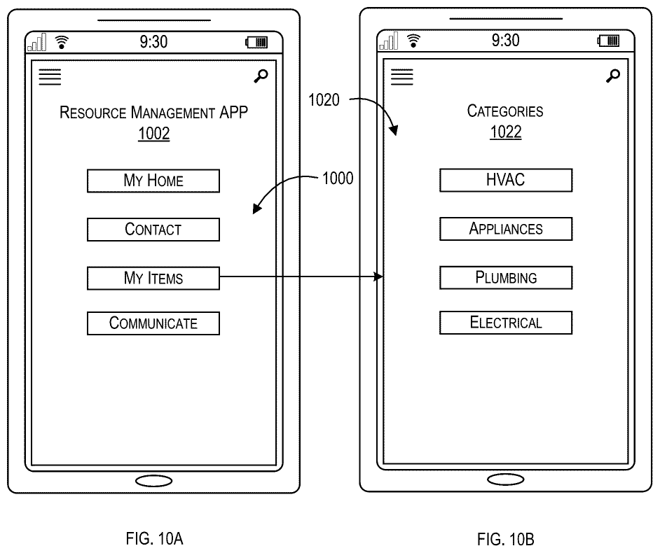

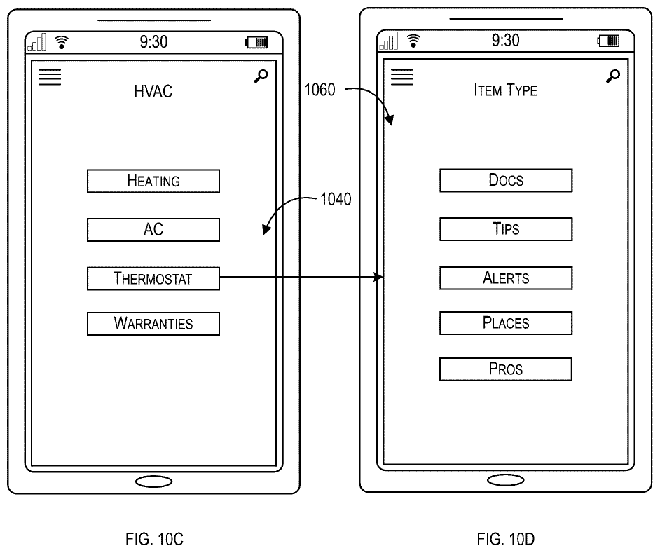

FIG. 10A is an example of user interface 1000 illustrating a landing page for a mobile application in accordance with an embodiment of the present disclosure. In an embodiment, the system 102 may provide multiple options to find the right content. The system 102 may facilitate the user to connect through a resource management app 1002. The resource management app 1002 may facilitate the user to see resources associated with a home, contacts, and personal items (My items). The App 1002 may store the resource/item details marked as personal items or my item in local storage and doesn't transmit data related to such items over a network. This ensures the privacy of user data. The system 102 may not collect data associated with such items unless requested by a user to identify any issue and resolve it.

FIG. 10B is an example of the user interface illustrating categories for selected entity types in accordance with an embodiment of the present disclosure. The general menu may include links to categories for each main feature of the home, along with its corresponding sub-features. When a user selects my home option in interface 1000, app 1002 may present categories 1022 to the user. The order of presentation of categories may be dynamically adjusted depending on the potential issue detected by the system 102. The example categories displayed on interface 1020 are for a home. The categories include HVAC, Appliances, plumbing, Electrical, etc. FIG. 10C is an example user interface illustrating a sub-category of resources in accordance with an embodiment of the present disclosure. The interface 1040 presents sub-categories for HVAC components. The HVAC sub-categories, for example, include a heating device, AC, Thermostat, etc. The interface may provide an option to explore warranties and other documents associated with any component/device/item/resource. Similarly, a list of components/subsystems under each category may be presented.

FIG. 10D is an example user interface 1060 illustrating item types associated with a resource that a user may browse in accordance with an embodiment of the present disclosure. In an embodiment, the system 102 may facilitate users to browse through the associated documents, present tips and alerts, and present places where the user's needs may be filled. Resources/Items under each of the categories may be added based on new purchase and sell transactions reported.

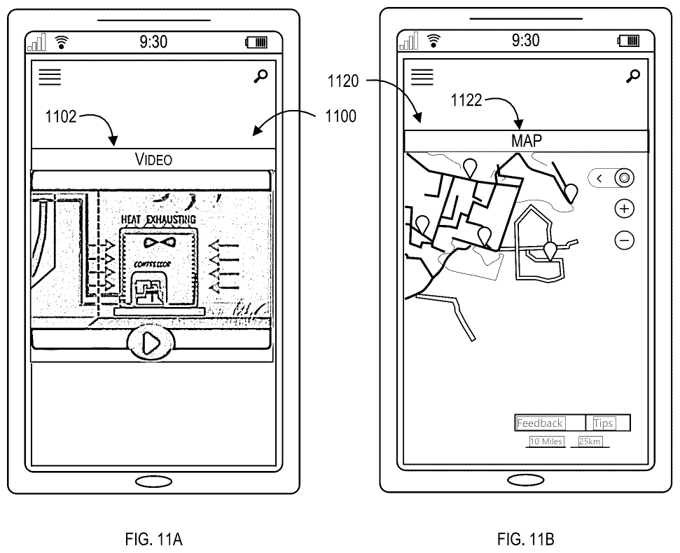

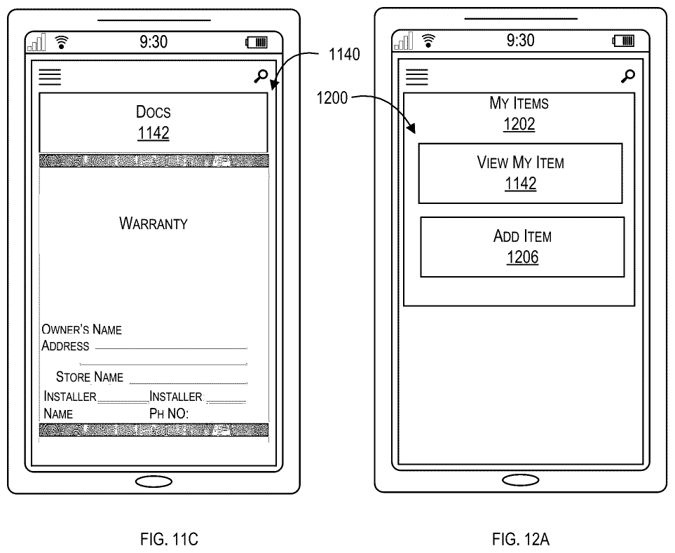

FIG. 11A-11C are example user interfaces illustrating different content types that may be shown to the user in accordance with an embodiment of the present disclosure. In an embodiment, the interface 1100 may present video content 1102 (e.g., do-it-yourself or professional repair help video) to the user that might help the user resolve an issue or get more detail about an item. In an embodiment, the interface 1120 may show map 1122 with tagged places of interest where users may get help. In an embodiment, interface 1140 may facilitate the users to show documents 1142 (e.g., warranty certificate) or share the document with a service provider. When the menu is used by Users such as homeowners, the menu connects homeowners with home-specific documents, alerts, and web links added by the PRO distributors and/or Residents. Links to products, services, Do-it-Yourself videos, annotated video, annotated audio, annotated maps, and websites to professionals may be added by the different stack holders depending on their role.

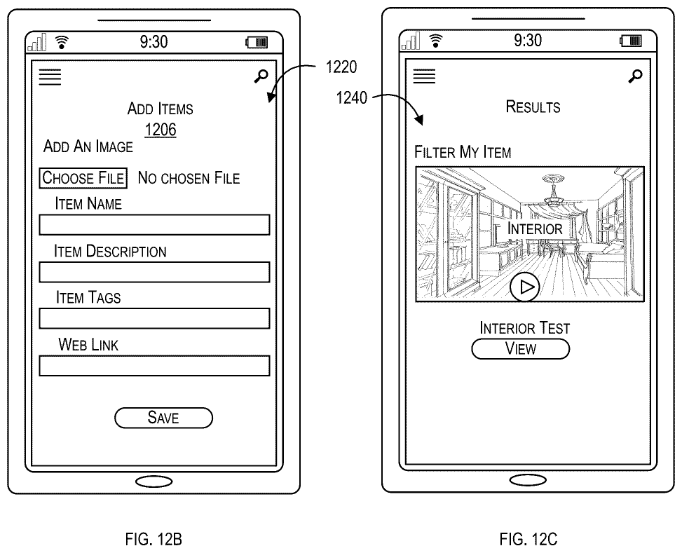

FIG. 12A-C is an example user interface used to add details associated with a resource in accordance with an embodiment of the present disclosure. In an embodiment, the interface 1200 may facilitate the users to maintain an updated list of items 1202. The user/professional distributor or service provider may view a list of existing items associated with an entity by selecting the option “view my item” 1204 and add a new item by selecting the option “add item” 1206. To add item 1206, the user may upload an image, assign a name to the item, add a description, add item tags, add price details, and weblink, as shown via interface 1220. In an embodiment, the system 102 may facilitate the user to, via an interface (e.g., Interface 1240) watch the interior view of a house and select an object in more detail. In an embodiment, the system 102 may support other 2D, 3D, AR, VR, and 360-degree video viewing experiences, where the users may select an object by pausing a video and get more details. In an embodiment, the user may add, manage, and collect web links utilizing a white label. PRO distributors may bulk upload the contents. The bulk uploaded contents may be classified, categorized, and tagged with matching resources. The contents uploaded by different stakeholders may be targeted for an individual model and/or home. The items that may be added to casalogy include websites, SoundCloud Audio, YouTube, LearnChurn items such as annotated Directories, Maps, and Photo Galleries.

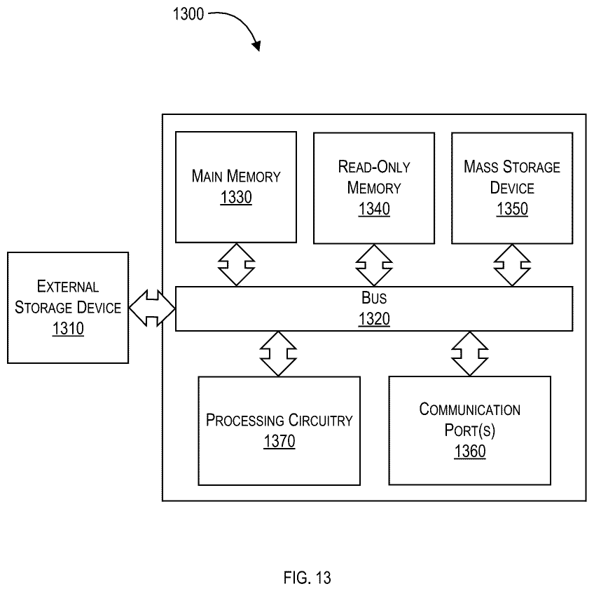

FIG. 13 illustrates an exemplary computer system 1300 in which or with which embodiments of the present invention may be utilized. Depending upon the particular implementation, the various process and decision blocks described above may be performed by hardware components, embodied in machine-executable instructions, which may be used to cause a general-purpose or special-purpose processor programmed with the instructions to perform the steps or the steps may be performed by a combination of hardware, software, firmware and/or involvement of human participation/interaction. As shown in FIG. 13, the computer system includes an external storage device 1310, bus 1320, main memory 1330, read-only memory 1340, mass storage device 1350, communication port 1360, and processor 1370.

Those skilled in the art will appreciate computer system 1300 may include more than one processing circuitry 1370 and communication ports 1360. Processing circuitry 1370 should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, processing circuitry 1370 is distributed across multiple separate processors or processing units, for example, multiple of the same type of processing units (e.g., two Intel Core i7 processors) or multiple different processors (e.g., an Intel Core i5 processor and an Intel Core i7 processor). Examples of processing circuitry 1370 include, but are not limited to, an Intel® Itanium® or Itanium 2 processor(s), or AMD® Opteron® or Athlon MP® processor(s), Motorola® lines of processors, System on Chip (SoC) processors or other future processors. Processing circuitry 1370 may include various modules associated with embodiments of the present invention.

Communication port 1360 may include a cable modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of electronic devices or communication of electronic devices in locations remote from each other. Communication port 1360 can be any RS-232 port for use with a modem-based dialup connection, a 10/100 Ethernet port, a Gigabit, or a 10 Gigabit port using copper or fiber, a serial port, a parallel port, or other existing or future ports. Communication port 1360 may be chosen depending on a network, such as a Local Area Network (LAN), Wide Area Network (WAN), or any network to which the computer system connects.

Memory 1330 may include Random Access Memory (RAM) or any other dynamic storage device commonly known in the art. Read-only memory 1340 can be any static storage device(s), e.g., but not limited to, a Programmable Read-Only Memory (PROM) chip for storing static information, e.g., start-up or BIOS instructions for processing circuitry 1370.

Mass storage 1350 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) 10 recorders, BLU-RAY 3D disc recorders, digital video recorders (DVRs, sometimes called a personal video recorder or PVRs), solid-state devices, quantum storage devices, gaming consoles, gaming media, or any other suitable fixed or removable storage devices, and/or any combination of the same. The non-volatile memory may also be used (e.g., to launch a boot-up routine and other instructions). Cloud-based storage may be used to supplement storage memory in 1330. Memory 1350 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firmware interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 1320 communicatively couples processor(s) 1370 with the other memory, storage, and communication blocks. Bus 1320 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1370 to a software system.

Optionally, operator and administrative interfaces, e.g., a display, keyboard, and a cursor control device, may also be coupled to bus 1320 to support direct operator interaction with computer systems. Other operator and administrative interfaces can be provided through network connections connected through communication port 1360. An external storage device 1210 can be any kind of external hard-drives, floppy drives, IOMEGA® Zip Drives, Compact Disc-Read-Only Memory (CD-ROM), Compact Disc-Rewritable (CD-RW), Digital Video Disk-Read Only Memory (DVD-ROM). The components described above are meant only to exemplify various possibilities. In no way should the aforementioned exemplary computer system limit the scope of the present disclosure.

The computer system 1300 may be accessed through a user interface. The user interface application may be implemented using any suitable architecture. For example, it may be a stand-alone application wholly implemented on the computer system 1300. The user interfaces application and/or any instructions for performing any of the embodiments discussed herein may be encoded on computer-readable media. Computer-readable media includes any media capable of storing data. In some embodiments, the user interface application is a client server-based application. Data for use by a thick or thin client implemented on an electronic device computer system 1300 is retrieved on-demand by issuing requests to a server remote to the computer system 1300. For example, computer device 1300 may receive inputs from the user via an input interface and transmit those inputs to the remote server for processing and generating the corresponding outputs. The generated output is then transmitted to the computer device 1300 for presentation to the user.

While embodiments of the present invention have been illustrated and described, it will be clear that the invention is not limited to these embodiments only. Numerous modifications, changes, variations, substitutions, and equivalents will be apparent to those skilled in the art without departing from the spirit and scope of the invention, as described in the claims.

Thus, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, terms “coupled to” and “coupled with” are also used euphemistically to mean “communicatively coupled with” over a network, where two or more devices are able to exchange data with each other over the network, possibly via one or more intermediary devices.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C, and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded to the widest scope consistent with the principles and novel features disclosed herein. It is contemplated that additional embodiments are within the spirit and true scope of the disclosed subject matter.

What is claimed is:

1. A method for management of resources associated with an entity, the method comprising:
monitoring, by a processing unit, real-time resource status associated with each of one or more resources associated with an entity;
identifying, by the processing unit, at least one action to be performed on at least one resource amongst the one or more resources, based on corresponding real-time resource status;
generating, by the processing unit, a context-aware search query related to the at least one action;
executing, by the processing unit, the context-aware search query to retrieve one or more contents associated with the at least one resource;
creating, by the processing unit, a personalized recommendation based on the one or more contents; and
providing, by the processing unit, the personalized recommendation to a user associated with the entity, for initiating the at least one action.

2. The method of claim 1, further comprising:
updating, by the processing unit, a centralized database coupled with the processing unit with information associated with the entity and the one or more resources, wherein the information comprises at least one of entity type, a list of the one or more resources and resources data, service provider data, content data, entity manager data, and entity developer data.

3. The method of claim 1, wherein the monitoring of real-time status associated with each of the one or more resources is performed using one or more sensors associated with each of the one or more resources, wherein the one or more sensors is any or combination of a vibration sensor, a magnetic flux sensor, an ultrasonic acoustic sensor, a strain gauge, a temperature sensor, a proximity sensor, a debris detection sensor, a force and load sensor, a displacement sensor, a position sensor, and an optical sensor.

4. The method of claim 1, further comprising, to monitor the real-time resource status, at least one:
receiving, by the processing unit, a trigger from the user to initiate the monitoring of the real-time resource status;
automatically initiating, by the processing unit, the monitoring of the real-time resource status of each of the one or more resource, at predefined intervals of time.

5. The method of claim 1, wherein the at least one action to be performed on the at least one resource comprises at least one of:
resolving an issue related to the at least one resource;
initiating maintenance of the at least one resource;
renewing warranty of the at least one resource;
replacing the at least one resource; and
upgrading the at least one resource.

6. The method of claim 1, wherein the context-aware search query comprises one or more keywords, context tags, resource details, and action details to precisely retrieve the one or more contents.

7. The method of claim 1, wherein generating the context-aware search query comprises receiving real-time inputs from the user to update the context-ware search query.

8. A system for management of resources associated with an entity, the system comprises:
a centralized database coupled with the system, wherein the centralized database comprises information associated with an entity and one or more resources associated with the entity, wherein the information comprises at least one of entity type, a list of the one or more resources, and resources data, service provider data, content data, entity manager data, and entity developer data;
one or more user devices enabling one or more users to use the system for management of the one or more resources;
a network to enable interaction between the one or more user to use the system for management of the one or more resources;
a processing unit comprising:
one or more processors; and
a memory communicatively coupled to the one or more processors, wherein the memory stores processor-executable instructions, which, on execution, cause the one or more processors to:
monitor real-time resource status associated with each of the one or more resources;
identify at least one action to be performed on at least one resource amongst the one or more resources, based on corresponding real-time resource status;
generate a context-aware search query related to the at least one action;
execute the context-aware search query to retrieve one or more contents associated with the at least one resource;
create a personalized recommendation based on the one or more contents; and
provide the personalized recommendation to a user associated with the entity, for initiating the at least one action.

9. The system of claim 8, wherein the one or more processors is further configured to update a centralized database coupled with the processing unit with information associated with the entity and the one or more resources, wherein the information comprises at least one of entity type, list of the one or more resources and resources data, service provider data, content data, entity manager data, and entity developer data.

10. The system of claim 8, further comprising one or more sensors associated with each of the one or more resources to monitor real-time resource status associated with each of the one or more resources, wherein the one or more sensors is any or combination of a vibration sensor, a magnetic flux sensor, an ultrasonic acoustic sensor, a strain gauge, a temperature sensor, a proximity sensor, a debris detection sensor, a force and load sensor, a displacement sensor, a position sensor, and an optical sensor.

11. The system of claim 8, wherein the one or more processors is further configured to, for monitoring the real-time resource status, at least one:
receiving a trigger from the user to initiate the monitoring of the real-time resource status;
automatically initiating the monitoring of the real-time resource status of each of the one or more resource, at predefined interval of time.

12. The system of claim 8, wherein the at least one action to be performed on the at least one resource comprises at least one of:
resolving an issue related to the at least one resource;
initiating maintenance of the at least one resource;
renewing warranty of the at least one resource;
replacing the at least one resource; and
upgrading the at least one resource.

13. The system of claim 8, wherein the context-aware search query comprises one or more keywords, context tags, resource details, and action details to precisely retrieve the one or more contents.

14. The system of claim 8, wherein generating the context-aware search query comprises receiving real-time inputs from the user to update the context-ware search query.

15. A non-transitory computer-readable medium including instructions stored thereon that when processed by one or more processors cause a processing unit to perform operations comprising:
monitoring real-time resource status associated with each of one or more resources associated with an entity;
identifying at least one action to be performed on at least one resource amongst the one or more resources, based on corresponding real-time resource status;
generating a context-aware search query related to the at least one action;
executing the context-aware search query to retrieve one or more contents associated with the at least one resource;
creating a personalized recommendation based on the one or more contents; and
providing the personalized recommendation to a user associated with the entity, for initiating the at least one action.

16. The non-transitory computer-readable medium of claim 15, further comprising:
updating a centralized database coupled with the processing unit with information associated with the entity and the one or more resources, wherein the information comprises at least one of entity type, a list of the one or more resources and resources data, service provider data, content data, entity manager data, and entity developer data.

17. The non-transitory computer-readable medium of claim 15, further comprising, to monitor the real-time resource status, at least one:
receiving a trigger from the user to initiate the monitoring of the real-time resource status;
automatically initiating the monitoring of the real-time resource status of each of the one or more resource, at predefined interval of time.

18. The non-transitory computer-readable medium of claim 15, wherein the at least one action to be performed on the at least one resource comprises at least one of:
resolving an issue related to the at least one resource;
initiating maintenance of the at least one resource;
renewing warranty of the at least one resource;
replacing the at least one resource; and
upgrading the at least one resource.

19. The non-transitory computer-readable medium of claim 15, wherein the context-aware search query comprises one or more keywords, context tags, resource details, and action details to precisely retrieve the one or more contents.

20. The non-transitory computer-readable medium of claim 15, wherein generating the context-aware search query comprises receiving real-time inputs from the user to update the context-ware search query.
